(19) United States
(12) Patent Application Publication
(10) Pub. No.: US 2026/0240241 A1
(43) Pub. Date: Aug. 20, 2026

(54) INDUCTIVELY HEATING AEROSOL-GENERATING DEVICE FOR USE WITH AN AEROSOL-GENERATING ARTICLE

(71) Applicant: Philip Morris Products S.A., Neuchatel (CH)

(72) Inventors: David Murray CROSS, Willian Letchworth (GB); Stuart Michael Ruan JONES, Meldreth Royston (GB); Patrick Charles SILVESTRINI, Neuchâtel (CH); Enrico STURA, Palézieux-Village (CH); Denis NIZOVTSEV, Le Locle (CH)

(73) Assignee: Philip Morris Products S.A., Neuchatel (CH)

(21) Appl. No.: 19/099,349

(22) PCT Filed: Aug. 9, 2023
(86) PCT No.: PCT/EP2023/072033

§ 371 Date: Jan. 28, 2025

(30) Foreign Application Priority Data
Aug. 11, 2022 (EP) 22189824.0

(51) Int. Cl. A24F 40/465; A24F 40/10; H05B 1/02; H05B 6/06; H05B 6/10

(52) U.S. Cl. CPC A24F 40/465; A24F 40/10; H05B 1/0252; H05B 6/06; H05B 6/108

(57) ABSTRACT

An aerosol-generating system is provided, including: an aerosol-generating article and an inductively heating aerosol-generating device for the article, the article including an aerosol-forming liquid and a susceptor arranged in an evaporation portion of the article for heating the liquid by interaction of the susceptor with an alternating magnetic field provided by the device, and the device including a DC power supply and an induction heating arrangement including power supply electronics including a DC/AC inverter connected to the supply and including a power switching amplifier with a transistor switch, a transistor switch driver circuit associated with the switch, and an LC load network including a capacitor and a cylindrical-helical induction coil, an interior space of the coil for removably receiving the evaporation portion of the article, and the coil having a non-circular flattened transverse cross-sectional shape including two opposing flat sections connected by two opposing at least partially curved sections.

The present disclosure relates to an inductively heating aerosol-generating device for use with an aerosol-generating article. The invention further relates to an aerosol-generating system comprising such a device and such an article.

Aerosol-generating devices and systems used for generating inhalable aerosols by inductively heating aerosol-forming substrates are generally known from prior art. Such systems and devices may comprise an induction heating arrangement including an induction coil for generating an alternating magnetic field. The field is used to induce at least one of heat generating eddy currents or hysteresis losses in a susceptor which is arranged in thermal proximity or direct physical contact with an aerosol-forming substrate that is capable to form inhalable aerosols upon heating. The susceptor and the substrate may be part of an aerosol-generating article that is receivable within the interior space of the induction coil. In particular, the substrate may be a liquid aerosol-forming substrate that is stored in a liquid reservoir of the article. The reservoir may be in fluid communication with a susceptor that is located in an evaporation portion of the article where the aerosol-forming liquid can be evaporated by interaction of the susceptor with the alternating magnetic field of the induction coil. Alternatively, the aerosol-forming substrate may be a solid or gel-like aerosol-forming substrate that is in thermal proximity or direct physical contact with a susceptor, wherein both the susceptor and the substrate are contained in an evaporation portion of the article. Alternatively, the susceptor may also be part of the aerosol-generating device.

In some articles, the susceptor may have a flat shape, such as a sheet-like shape, which offers a large surface to mass ratio. A large surface to mass ratio is beneficial for efficiently exploiting the heat generated by the susceptor as well as well as for enhancing the heat transfer from the susceptor to the aerosol-forming substrate.

During a user experience, the induction heating arrangement may be operated either continuously or on demand, in particular in an intermittent mode, such as on a puff by puff basis. While in the continuous operation mode the susceptor is permanently maintained at a temperature level sufficient to form a satisfactory amount of aerosol, it can be a challenge to achieve a sufficient temperature level within a short period of time if the heating system is to be operated intermittently, such as on a user's demand.

Therefore, it would be desirable to have an aerosol-generating device and an aerosol-generating system for inductively heating an aerosol-forming substrate with the advantages of prior art solutions, whilst mitigating their limitations. In particular, it would be desirable to have an aerosol-generating device and an aerosol-generating system for inductively heating an aerosol-forming substrate in thermal proximity or direct physical contact with a flat, in particular sheet-like susceptor, which each allow to achieve a higher heating efficiency, in particular a sufficient temperature level within a shorter period of time.

According to the invention there is provided an inductively heating aerosol-generating device for use with an aerosol-generating article. The article comprises an aerosol-forming substrate and a flat, in particular sheet-like susceptor, wherein the susceptor is arranged in an evaporation portion of the article and configured for heating the aerosol-forming substrate by interaction of the susceptor with an alternating magnetic field provided by the aerosol-generating device. The device comprises a DC power supply and an induction heating arrangement, which comprises a power supply electronics comprising a DC/AC inverter connected to the DC power supply. The DC/AC inverter comprises a power switching amplifier with at least one transistor switch, at least one transistor switch driver circuit associated with the transistor switch and an LC load network comprising at least a capacitor and a cylindrical-helical induction coil. An interior space of the induction coil is configured for removably receiving at least the evaporation portion of the aerosol-generating article. The cylindrical-helical induction coil has a non-circular flattened transverse cross-sectional shape comprising, in particular consisting of two opposing flat sections connected by two opposing at least partially curved sections.

As used herein, the term “aerosol-generating device” is used to describe an electrically operated device that is capable of interacting with at least one aerosol-generating article comprising an aerosol-forming substrate, in particular an aerosol-forming liquid, and a susceptor such as to generate an aerosol by inductively heating the substrate via interaction of the susceptor with an alternating magnetic field provided by the device. Preferably, the aerosol-generating device is a puffing device for generating an aerosol that is directly inhalable by a user through the user's mouth. In particular, the aerosol-generating device is a hand-held aerosol-generating device.

According to the invention, it has been found that the heating efficiency of an inductively heating aerosol-generating device having an induction coil intended for heating a flat, in particular sheet-like susceptor can be improved by adapting the geometry of the magnetic field within the interior space of the induction coil, where the susceptor is to be placed, to the flat shape of the susceptor. In particular, it has been found that by flatting the transverse cross-sectional shape of the induction coil, the radial distance between the induction coil and the major surfaces (main surfaces) of the flat susceptor (i.e. the main surfaces of the susceptor determining the flat susceptor geometry) can be reduced, given the susceptor is placed such that the major surfaces are facing or are aligned, in particular substantially parallel, with the two opposing flat sections of the transverse cross-sectional shape of the outer circumference of the induction coil, i.e. such that a flat plane defined by the flat susceptor geometry is aligned, in particular substantially parallel, with a flat plane defined by the two opposing flat sections of the outer circumference of the induction coil (The flat plane defined by the two opposing flat sections of the outer circumference of the induction coil may include the major axis of symmetry defined below and further may be perpendicular to the minor axis of symmetry defined below). The reduced radial distance leads to an increase of the magnetic field strength at the susceptor location which in turn causes an increase of the heating efficiency. Thus, the level of heat generated in the susceptor for a given level of power passing through the induction coil is increased which-inter alia-allows to reach a desired temperature level within a shorter period of time.

The efficiency of the inductively heating aerosol-generating device is further enhanced due to the use of a cylindrical-helical induction coil which advantageously allows for generating a homogeneous alternating magnetic field.

Preferably, the non-circular flattened transverse cross-sectional shape of the induction coil comprises a minor axis of symmetry and a major axis of symmetry. The minor axis of symmetry may extend between the two opposing flat sections of the induction coil. Vice versa, the major axis of symmetry may extend between the two opposing at least partially curved sections of the induction coil.

Preferably, a ratio of a maximum distance along the major axis of symmetry between the two opposing at least partially curved sections to a maximum distance along the minor axis of symmetry between the two opposing flat sections is in a range between 1.2 and 3, in particular between 1.5 and 2.5. These ratios are particularly advantageous with regard to a proper match between the geometry of the magnetic field and a flat shape of the susceptor to be heated.

In order to arrange the induction coil as close as possible to the interior space of the induction coil where the susceptor is to be placed, a maximum distance along the minor axis of symmetry between the two opposing flat sections may be in a range between 4 millimeter and 7 millimeter, in particular between 5 millimeter and 6 millimeter.

Likewise, a maximum distance along the major axis of symmetry between the two opposing at least partially curved sections may be in a range between 7 millimeter and 10 millimeter, in particular between 8 millimeter and 9 millimeter.

Preferably, the two opposing flat sections are substantially parallel to each other. A parallel configuration particularly helps to match the magnetic field geometry to a susceptor having a sheet-like shape. In particular, each of the two opposing flat sections may be a substantially straight line.

The shape of the two at least partially curved sections is chosen such as to provide a smooth transition between the two opposing flat sections, to ensure a smooth bending. Preferably, the at least partially curved sections is one of substantially semi-circular, substantially semi-oval, substantially semi-elliptical or substantially parabolic.

In particular, (the respective endpoints of) each of the two opposing flat sections (connecting the two opposing flat sections) may be tangent to (the respective endpoints of) the two opposing flat sections. Thus, the transition between the two opposing flat sections is particularly smooth.

Preferably, the non-circular flattened transverse cross-sectional shape of the induction coil is obround. As used herein, the term “obround” defines a shape consisting of two semicircles connected by parallel lines tangent to their endpoints. Accordingly, the induction coil may have an obround-cylindrical shape.

In general, the cylindrical-helical induction coil may be formed by one or more turns of a coil wire. For example, the induction coil comprises 3 to 6 turns, in particular 4 to 5 turns. The number of turns does not necessarily need to be an integer number. It can also be any number between two integer numbers.

Preferably, the coil wire may have a circular cross-section.

The coil wire may be one of a solid wire, a stranded wire and a Litz wire.

As the induction coil is driven by an AC current, the current through the coil wire only flows close to the outer surface of the coil wire. Hence, the diameter of the coil wire does not need to be large to carry a large current. In order to realize a compact coil design with a sufficiently large number of turns per length unit, it may be beneficial if the coil wire has a diameter in the range between 0.8 millimeter and 1.5 millimeter, in particular between 1 millimeter and 1.2 millimeter.

Preferably, the induction coil has an axial length extension that is similar to an axial length extension of the susceptor measured in the same direction when received in the interior space of the induction coil. The induction coil may have an axial length in a range between 4 millimeter and 12 millimeter, in particular between 5 millimeter and 8 millimeter.

Preferably, there is a gap between adjacent turns of the induction coil. That is, a pitch of the helical induction coil may be larger than an extension of the cross-section of the coil wire in the axial direction as seen in a longitudinal cross-section of the induction coil. In particular, where the coil wire has a circular cross-section, a pitch of the helical induction coil may be larger than a diameter of the coil wire. As a consequence, the coil wire of adjacent turns does not come into contact which each other. This allows to use a coil wire without wire insulation. Nevertheless, the coil wire may be insulated coil wire. For example, the coil wire may be a coated copper wire, for example an enamel coated copper wire. In addition, the gap between adjacent turns of the induction coil serves for better heat dissipation and thus leads to less resistive power losses in the coil winding. A gap between adjacent turns also helps to reduce undesired ring/cross effects. A (center-to-center) distance between adjacent portions of the coil wire of adjacent turns may be in a range between 1.1 and 1.4, in particular 1.2 and 1.3, times an extension of the cross-section of the coil wire in the axial direction as seen in a longitudinal cross-section of the induction coil. In particular, where the coil wire has a circular cross-section, a (center-to-center) distance between adjacent portions of the coil wire of adjacent turns is in a range between 1.1 and 1.4, in particular 1.2 and 1.3, times a diameter of the coil wire. These ranges have proven to provide a sufficiently large distance which still allows for a compact coil design, that is, a sufficiently large number of turns per length unit.

In addition, the aerosol-generating device may comprise a flux concentrator arranged around the induction coil and configured to distort the alternating magnetic field of the induction coil towards the interior space of interior space of the induction coil in use.

In particular, the flux concentrator may comprise a sleeve portion circumferentially surrounding the induction coil and in addition an annular protrusion portion at each axial end of the sleeve portion protruding radially inward beyond the sleeve portion, such that the induction coil is axially arranged between the annular protrusion portions. Advantageously, the annular protrusion portions at each axial end of the sleeve portion protruding radially inward beyond the sleeve portion lead to a concentration or focusing of the magnetic field within the interior space of the induction coil. Thus, the level of heat generated in the susceptor for a given level of power passing through the induction coil is increased in comparison to an induction coil having no flux concentrator or only a sleeve-shaped flux concentrator without annular protrusion portions at each axial end. This also helps to increase the heating efficiency, in particular to reach a desired temperature level in a shorter time period. In addition to that, the flux concentrator acts as a magnetic shield which is capable of reducing the extent to which the magnetic field propagates beyond the induction coil.

Preferably, the flux concentrator comprises or is made of one or more layers of a flux concentrator foil. According to a preferred setup of the flux concentrator, each of the annular protrusion portions may be made of one or more layers of a flux concentrator foil, wherein the one or more layers of the annular protrusion portions extend in the radial outward direction at least to, preferably beyond an outer circumference of the induction coil. On top of the annular protrusion portions, the sleeve portion may be made of one or more layers of a flux concentrator foil which surround the induction coil and each of the annular protrusion portions. According to an alternative setup of the flux concentrator, the sleeve portion may be made of one or more layers of a flux concentrator foil surrounding the induction coil, whereas each of the annular protrusion portions may be made of one or more layers of a flux concentrator foil, ending in the radial direction flush with the outer circumference of the sleeve portion.

At least one of the annular protrusion portions, preferably the more distal annular protrusion portions may comprise a recess or feedthrough opening for passing through connecting leads for the induction coil. Where the flux concentrator is formed by winding a flux concentrator foil, the recess or feedthrough opening can be cut into the annular protrusion portion after winding the flux concentrator foil.

Similar to the induction coil, the flux concentrator may have a non-circular flattened transverse cross-sectional shape corresponding to the non-circular flattened transverse cross-sectional shape of the induction, that is, a non-circular flattened transverse cross-sectional shape comprising, in particular consisting of two opposing flat sections connected by two opposing at least partially curved sections. In particular, the transverse cross-sectional shape of the flux concentrator may be obround.

The aerosol-generating device may further comprise a coil support which the induction coil and—if present—the flux concentrator are supported on.

The coil support may comprise a support tube, in particular a cylindrical support tube, wherein the induction coil is arranged around an outer circumference of the support tube.

An interior space of the support tube may form a receiving cavity for removably receiving at least a portion, in particular at least the evaporation portion of the aerosol-generating article the device is configured to be used with.

In order to provide a lateral confinement of the coil winding in the axial direction, the coil support may comprise a circumferential collar at each axial end of the support tube.

At least one of the collars may comprise a recess or feedthrough opening for passing through connecting leads for the induction coil.

Similar to the induction coil, the outer circumference of the support tube may also have a non-circular flattened transverse cross-sectional shape comprising, in particular consisting of two opposing flat sections connected by two opposing at least partially curved sections. That is, the outside (outer face) of the support tube along its outer circumference may comprise, in particular may consist of two opposing flat outside portions connected by two opposing at least partially curved outside portions. In this configuration, the induction coil may be wound around the outer circumference of the support tube such that the non-circular flattened transverse cross-sectional shape of the induction coil follows the non-circular flattened transverse cross-sectional shape of the outer circumference of the support tube.

Preferably, the non-circular flattened transverse cross-sectional shape of the support tube is obround, in particular where the transverse cross-sectional shape of the induction coil is obround as well. Accordingly, the support tube and the induction coil may have an obround-cylindrical shape, that is, the shape of a flattened cylinder with two opposing plane side wall portions parallel to each other and two opposing side hemispherical wall portions between the two opposing plane side wall portions.

Where the outer circumference of the support tube has a non-circular flattened transverse cross-sectional shape as described above, each of the above described collars—if present—may also have a non-circular flattened transverse cross-sectional shape corresponding to the non-circular flattened transverse cross-sectional shape of the outer circumference of the support tube. In particular, each collar may have obround transverse cross-sectional shape.

In order to stabilize the coil winding, the outer circumference of the support tube may comprise a wire recess pattern the coil wire is received in. The wire recess pattern is preferably is chosen such that it corresponds to a desired a winding pattern of the induction coil. As the induction is a cylindrical-helical induction coil, the wire recess pattern preferably is also a helical wire recess pattern.

In addition, the wire recess pattern allows to further reduce the radial distance between the induction coil and the susceptor location within the interior space of the induction coil. As already described above, the reduced radial distance leads an increase of the magnetic field strength at the location of the susceptor which in turn causes an increase of the heating efficiency. Thus, the level of heat generated in the susceptor for a given level of power passing through the induction coil is increased, which—in addition to the non-circular flattened transverse cross-sectional shape of the outer circumference of the support tube—further serves to reach a desired temperature level within a shorter period of time. The larger the depth of the recesses of the wire recess pattern, the better the magnetic field strength at the susceptor location within the interior space of the induction coil. For example, where the coil wire has a circular cross-section, a depth of the recesses of the wire recess pattern in the radial direction preferably is in a range between 0.2 and 0.8, in particular 0.3 and 0.5, times a diameter of the coil wire.

The outer circumference of the support tube may further comprise a flux concentrator recess for each of the annular protrusion portions of the flux concentrator, in which a radially inward end of the respective annular protrusion portion is received. Due to this, the annular protrusion portions are safely supported which helps to prevent the flux concentrator from being displaced. Otherwise, a displacement could lead to an undesired change in the inductance of the induction coil and an undesired change of the magnetic field density in the interior space of the induction coil.

With regard to an easy and inexpensive manufacture, the coil support may comprise or may be made of plastics. Where the induction heating module must comply with specific regulatory requirements, the coil support may comprise or may be made of a bisphenol A-free plastic.

According to the invention, the heating arrangement comprises a power supply electronics comprising a DC/AC inverter connected to the DC power supply, wherein the DC/AC inverter comprises a power switching amplifier with at least one transistor switch, at least one transistor switch driver circuit associated with the transistor switch and an LC load network comprising at least a capacitor. To this extent, it has been further found that usage of a switching power amplifier is beneficial with regard to a good heating efficiency for a given, in particular limited power available from DC power supply, such as a battery.

Preferably, the switching power amplifier is a single-ended switching power amplifier, which is less complex than power amplifiers in a push-pull configuration.

In particular, the power switching amplifier may comprises a single transistor switch, which also makes the amplifier less complex.

Preferably, the switching power amplifier is one of a class-C power amplifier, a class-D power amplifier and a class-E power amplifier.

Where the DC/AC inverter includes a Class-E power amplifier, the switching power amplifier may comprise the following components: a transistor switch, a transistor switch supply circuit for supplying a switching signal (gate-source voltage) to the transistor switch, and an LC load network comprising a shunt capacitor and a series connection of a capacitor and inductor, wherein the inductor corresponds to the induction coil used to generate an alternating magnetic field for inductive heating. The transistor switch may comprise a Field Effect Transistor T (FET), for example a Metal-Oxide-Semiconductor Field Effect Transistor (MOSFET). In addition, the switching power amplifier may comprise a choke for supplying a DC supply voltage from the DC power supply to the LC load network.

Where the DC/AC inverter includes a Class-D power amplifier, the switching power amplifier may comprise the following components: two transistors connected to the DC power supply, two switching elements for switching the two transistors on and off, and an LC load network comprising a first capacitor and a series connection of a capacitor and inductor, wherein the inductor corresponds to the induction coil used to generate an alternating magnetic field for inductive heating. The switching elements are controllable/controlled at high frequency in a manner so as to make sure that one of the two transistors has been switched off at the time the other of the two transistors is switched on. In addition, there can be a second capacitor symmetrically arranged to the first capacitor.

The aerosol-generating device may comprise a device housing which the induction heating arrangement, and the DC power supply are located or arranged in.

The aerosol-generating device, in particular the device housing may comprise an insertion opening giving access to the interior space of the induction coil or the interior space of the support tube of the induction heating module in order to enable insertion of an aerosol-generating article therein.

The aerosol-generating device may further comprise a receiving cavity for removably receiving at least an evaporation portion of the aerosol-generating article. The receiving cavity may be located at least partially within the interior space of the induction coil or the interior space of the support tube, if present. In particular, the receiving cavity may be formed at least partially by the interior space of the induction coil or the support tube, in particular by the interior space of the support tube, if present. The induction coil may be arranged such as to surround at least a portion of the receiving cavity, in particular such as to surround at least the evaporation portion of the aerosol-generating article, when it is received in the receiving cavity.

The aerosol-generating device may be configured to be operated continuously following activation of the system or intermittently, such as on a puff by puff basis.

The LC network may further comprise a shunt capacitor in parallel to the transistor switch. In addition, DC/AC converter may comprise a choke inductor for supplying a DC supply voltage from the DC power supply.

The aerosol-generating device preferably is configured to generate a high-frequency varying magnetic field. As referred to herein, the high-frequency varying magnetic field may have a frequency in a range between 500 kHz (kilo-Hertz) to 30 MHz (Mega-Hertz), in particular between 5 MHz (Mega-Hertz) to 15 MHz (Mega-Hertz), preferably between 5 MHz (Mega-Hertz) and 10 MHz (Mega-Hertz).

The aerosol-generating device may further comprise a controller configured to control operation of the device. In particular, the controller may be configured to control operation of the inductive heating arrangement, preferably in a closed-loop configuration, for controlling heating of the aerosol-forming substrate to a pre-determined operating temperature. Depending on at least one of the type of the aerosol-forming substrate to be heated, the configuration of the susceptor and the arrangement of the susceptor relative to the aerosol-forming substrate, the operating temperature may be in a range between 180 degree Celsius and 370 degree Celsius, in particular between 180 degree Celsius and 240 degree Celsius or between 280 degree Celsius and 370 degree Celsius.

The controller may comprise a microprocessor, for example a programmable microprocessor, a microcontroller, or an application specific integrated chip (ASIC) or other electronic circuitry capable of providing control. The controller may comprise further electronic components, in particular parts of the DC/AC inverter and/or a power amplifier. In particular, the inductive heating module may be-at least partially-part of the controller.

The aerosol-generating device may further comprise a puff detector, such as a microphone or a pressure sensor, for detecting a user's puff, that is, the onset of a user experience when a user starts puffing on the device. The puff detector may be operatively connected to the controller. By this, the detection of the occurrence of a puff by means of the puff detector may trigger the power delivery to the induction coil for generating an aerosol. That is, the controller may be configured to start operation of the heating arrangement, in particular generation of an alternating magnetic field in response to the puff detector detecting the occurrence of a user's puff.

According to the invention, the DC power supply is configured to provide a DC supply voltage and a DC supply current to the inductive heating arrangement Preferably, the DC power supply is a battery such as a lithium iron phosphate battery. The DC power supply may have sufficient capacity to allow for the continuous generation of aerosol for a period of around six minutes or for a period that is a multiple of six minutes. Likewise, the power supply may have sufficient capacity to allow for a predetermined number of puffs or discrete activations of the inductive heating arrangement.

The present invention further relates to an aerosol-generating system comprising an aerosol-generating device according to the present invention and as described herein. The system further comprises an aerosol-generating article for use with the aerosol-generating device. The article comprises an aerosol-forming substrate and a flat, in particular sheet-like susceptor, the susceptor being arranged in an evaporation portion of the article and configured for heating the aerosol-forming substrate by interaction of the susceptor with an alternating magnetic field provided by the aerosol-generating device.

As used herein, the term “aerosol-generating system” refers to the combination of an aerosol-generating article as further described herein with an aerosol-generating device according to the invention and as described herein. In the system, the article and the device cooperate to generate a respirable aerosol.

As used herein, the term “aerosol-generating article” refers to an article comprising at least one aerosol-forming substrate that, when heated, releases volatile compounds that can form an aerosol. Preferably, the aerosol-generating article is a heated aerosol-generating article. That is, an aerosol-generating article which comprises at least one aerosol-forming substrate that is intended to be heated rather than combusted in order to release volatile compounds that can form an aerosol. The aerosol-generating article may be a consumable, in particular a consumable to be discarded after a single use. Preferably, the article may include a liquid aerosol-forming substrate, that is, an aerosol-forming liquid. Alternatively, the article may include a solid aerosol-forming substrate or a gel-like aerosol-forming substrate, or a combination thereof.

As used herein, the term “aerosol-forming substrate” in general denotes a substrate formed from or comprising an aerosol-forming material that is capable of releasing volatile compounds upon heating in order to generate an aerosol. The aerosol-forming substrate is intended to be heated rather than combusted to release the aerosol-forming volatile compounds. The aerosol-forming substrate may be a solid aerosol-forming substrate, a liquid aerosol-forming substrate, a gel-like aerosol-forming substrate, or any combination thereof. Preferably, the aerosol-forming substrate is a liquid aerosol-forming substrate, that is an aerosol-forming liquid. The aerosol-forming liquid may contain both, solid and liquid aerosol-forming material or components. The aerosol-forming substrate, in particular the aerosol-forming liquid may comprise a tobacco-containing material containing volatile tobacco flavor compounds, which are released from the substrate upon heating. Alternatively or additionally, the aerosol-forming substrate, in particular the aerosol-forming liquid may comprise a non-tobacco material. The aerosol-forming substrate, in particular the aerosol-forming liquid may further comprise an aerosol former. Examples of suitable aerosol formers are glycerin and propylene glycol. The aerosol-forming substrate, in particular the aerosol-forming liquid may also comprise other additives and ingredients, such as nicotine or flavourants. In particular, the aerosol-forming liquid may include water, solvents, ethanol, plant extracts and natural or artificial flavors. The aerosol-forming liquid may be a water-based aerosol-forming liquid or an oil-based aerosol-forming liquid. The aerosol-forming substrate may also be a paste-like material, a sachet of porous material comprising aerosol-forming substrate, or, for example, loose tobacco mixed with a gelling agent or sticky agent, which could include a common aerosol former such as glycerin, and which is compressed or molded into a plug.

As used herein, the term “susceptor” refers to an element that is capable to convert electromagnetic energy into heat when subjected to a varying magnetic field. This may be the result of at least one of hysteresis losses or eddy currents which are induced in the susceptor, depending on the electrical and magnetic properties of the susceptor material. Hysteresis losses occur in ferromagnetic or ferrimagnetic susceptors due to magnetic domains within the susceptor material being switched under the influence of a varying magnetic field. Eddy currents may be induced if the susceptor is electrically conductive. In case of an electrically conductive ferromagnetic or ferrimagnetic susceptor, heat can be generated due to both, eddy currents and hysteresis losses.

Accordingly, the susceptor may be formed from any material that can be inductively heated to a temperature sufficient to generate an aerosol from the aerosol-forming substrate. Preferred susceptors comprise a metal or carbon. A preferred susceptor may comprise a ferromagnetic material, for example ferritic iron, or a ferromagnetic steel or stainless steel. A suitable susceptor may be, or comprise, aluminum. Preferred susceptors may be formed from 400 series stainless steels, for example grade 410, or grade 420, or grade 430 stainless steel.

The susceptor may comprise a variety of geometrical configurations, depending—inter alia—on the type of the aerosol-forming substrate.

The flat, in particular sheet-like susceptor may comprise or may be a susceptor blade, a susceptor strip or a susceptor plate. In particular where the substrate is a liquid, that is, an aerosol-forming liquid, the susceptor may comprise or may be a mesh susceptor.

In any of these configurations, the susceptor advantageously is capable to perform both functions: wicking (conveying) and heating the aerosol-forming liquid. Accordingly any of the aforementioned configurations, the susceptor may be considered a liquid-conveying susceptor.

Where the aerosol-forming substrate is a liquid substrate, the article may comprise a liquid reservoir for storing aerosol-forming liquid. Preferably, the susceptor is in fluid communication with the liquid reservoir in which the aerosol-forming liquid is stored.

Further features and advantages of the aerosol-generating system have been described with regard to the induction heating module and the aerosol-generating device of the present invention, and equally apply.

As used herein, the terms “radial” and “axial” refer to the cylindrical geometry of the cylindrical induction coil.

The invention is defined in the claims. However, below there is provided a non-exhaustive list of non-limiting examples. Any one or more of the features of these examples may be combined with any one or more features of another example, embodiment, or aspect described herein.

Example Ex1: An inductively heating aerosol-generating device for use with an aerosol-generating article, the article comprising an aerosol-forming substrate and a flat, in particular sheet-like susceptor, the susceptor being arranged in an evaporation portion of the article and configured for heating the aerosol-forming substrate by interaction of the susceptor with an alternating magnetic field provided by the aerosol-generating device, wherein the device comprises a DC power supply and an induction heating arrangement, the heating arrangement comprising a power supply electronics comprising a DC/AC inverter connected to the DC power supply, wherein the DC/AC inverter comprises a power switching amplifier with at least one transistor switch, at least one transistor switch driver circuit associated with the transistor switch and an LC load network comprising at least a capacitor and a cylindrical-helical induction coil, wherein an interior space of the induction coil is configured for removably receiving at least the evaporation portion of the aerosol-generating article, wherein the cylindrical-helical induction coil has a non-circular flattened transverse cross-sectional shape comprising, in particular consisting of two opposing flat sections connected by two opposing at least partially curved sections.

Example Ex2: The induction heating arrangement according to example Ex1, wherein the non-circular flattened transverse cross-sectional shape comprises a minor axis of symmetry and a major axis of symmetry.

Example Ex3: The induction heating arrangement according to example Ex2, wherein a ratio of a maximum distance along the major axis of symmetry between the two opposing at least partially curved sections to a maximum distance along the minor axis of symmetry between the two opposing flat sections is in a range between 1.2 and 3, in particular between 1.5 and 2.5.

Example Ex4: The induction heating arrangement according to any one of example Ex2 or example Ex3, wherein a maximum distance along the minor axis of symmetry between the two opposing flat sections is in a range between 4 millimeter and 7 millimeter, in particular between 5 millimeter and 6 millimeter.

Example Ex5: The induction heating arrangement according to any one of examples Ex2 to Ex4, wherein a maximum distance along the major axis of symmetry between the two opposing at least partially curved sections is in a range between 7 millimeter and 10 millimeter, in particular between 8 millimeter and 9 millimeter.

Example Ex6: The induction heating arrangement according to any one of the preceding examples, wherein the two opposing flat sections are parallel to each other.

Example Ex7: The induction heating arrangement according to any one of the preceding examples, wherein each of the two opposing flat sections is a substantially straight line.

Example Ex8: The induction heating arrangement according to any one of the preceding examples, wherein each of the two opposing at least partially curved sections is substantially semi-circular, substantially semi-oval, substantially semi-elliptical or substantially parabolic.

Example Ex9: The induction heating arrangement according to any one of the preceding examples, wherein the non-circular flattened transverse cross-sectional shape of the induction coil is obround.

Example Ex10: The induction heating arrangement according to any one of the preceding examples, wherein the induction coil has a cylindrical obround shape.

Example Ex11: The induction heating arrangement according to any one of the preceding examples, wherein the induction coil which is formed by one or more turns of a coil wire, the coil wire having a circular cross-section.

Example Ex12: The induction heating arrangement according to any one of the preceding examples, wherein the switching power amplifier is a single-ended switching power amplifier.

Example Ex13: The induction heating arrangement according to any one of the preceding examples, wherein the switching power amplifier is one of a class-C power amplifier, a class-D power amplifier and a class-E power amplifier.

Example Ex14: The induction heating arrangement according to any one of the preceding examples, wherein the inductive heating arrangement is configured to generate an alternating magnetic field in the range between 500 kHz to 30 MHz, in particular between 5 MHz to 15 MHz, preferably between 5 MHz and 10 MHz.

Example Ex15: An aerosol-generating system comprising an aerosol-generating device according to any one of the preceding examples and an aerosol-generating article for use with the aerosol-generating device, the article comprising an aerosol-forming substrate and a flat, in particular sheet-like susceptor, the susceptor being arranged in an evaporation portion and configured for heating the aerosol-forming substrate by interaction of the susceptor with an alternating magnetic field provided by the aerosol-generating device.

Examples will now be further described with reference to the figures in which:

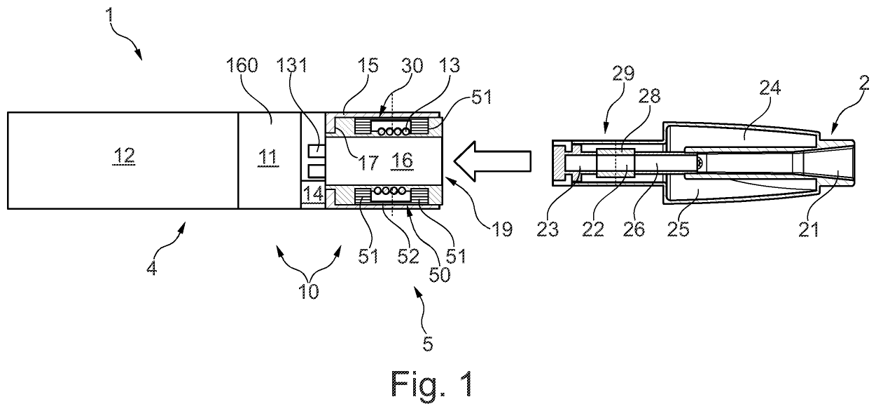

FIG. 1 shows an exemplary embodiment of an aerosol-generating system according to the present invention in a longitudinal cross-sectional view;

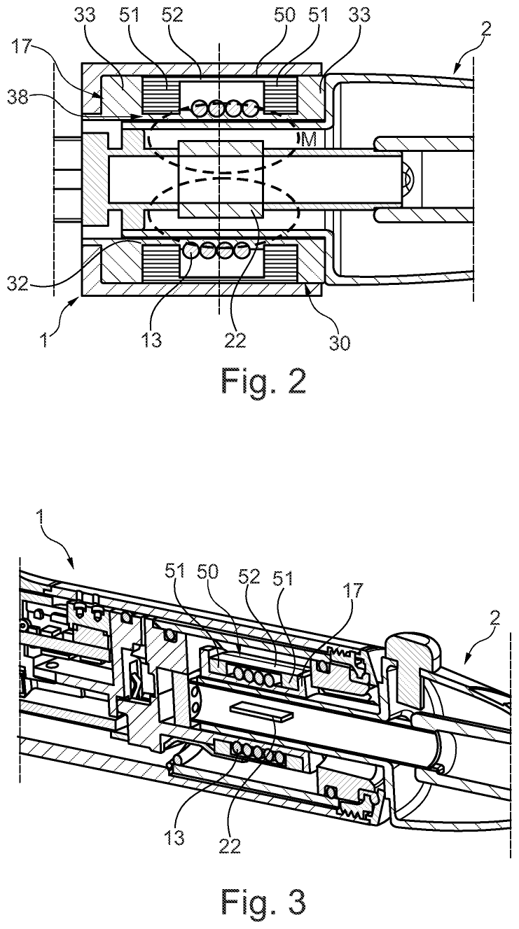

FIG. 2 shows a detailed longitudinal cross-sectional view of the aerosol-generating system according to FIG. 1;

FIG. 3 shows details of the aerosol-generating system according to FIG. 1 in a perspective longitudinal cross-sectional view;

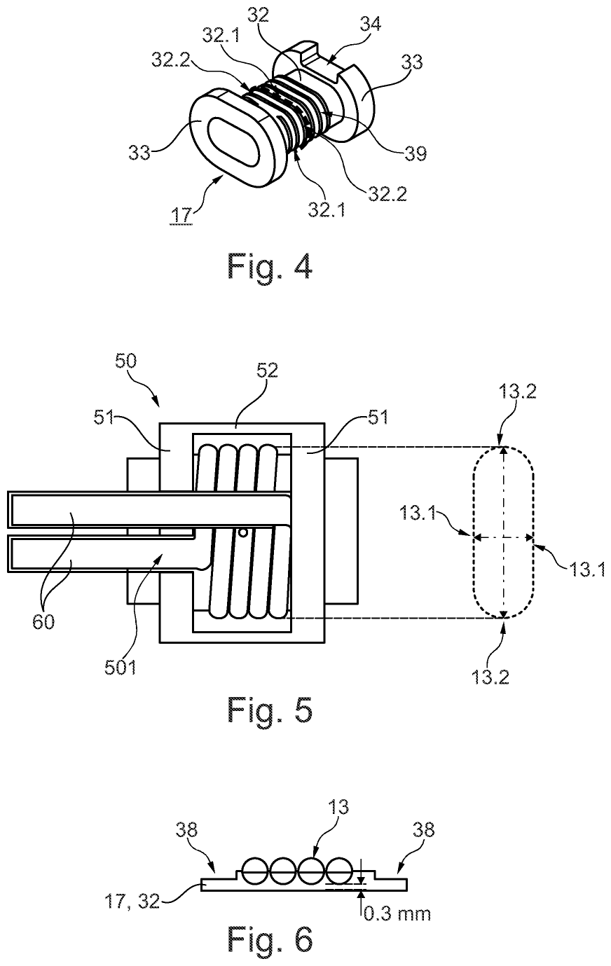

FIG. 4 shows details of a coil support used in the aerosol-generating device according FIG. 1;

FIG. 5 shows details of the inductive heating arrangement used in the aerosol-generating device according FIG. 1;

FIG. 6 shows further details of the coil support used in the aerosol-generating device according FIG. 1;

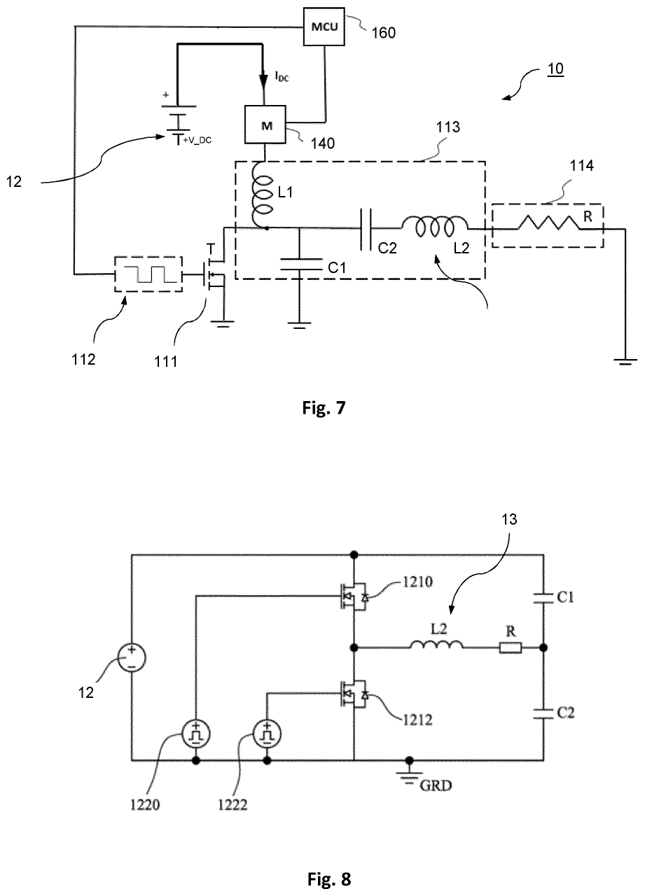

FIG. 7 shows details of a first embodiment of a power supply electronics that can be used in the aerosol-generating device according FIG. 1; and

FIG. 8 shows details of a second embodiment of a power supply electronics that can be alternatively used in the aerosol-generating device according FIG. 1.

FIGS. 1-3 show a schematic cross-sectional illustration of an aerosol-generating system 1 according to an exemplary embodiment of the present invention. The system 1 is configured to generate an inhalable aerosol by inductively heating a susceptor that is in thermal contact with a liquid aerosol-forming substrate 25, hereafter also denoted as aerosol-forming liquid 25. The system 1 comprises two main components: an aerosol-generating article 2 and an aerosol-generating device 1 for use with the article 2. While the article 2 includes a susceptor 22 and the aerosol-forming liquid 25 to be heated, the device 1 comprises a receiving cavity 16 for receiving the article 2, and an inductive heating arrangement 10 that is configured to generate an alternating magnetic field for inductively heating the susceptor 22 and thus for vaporizing the aerosol-forming liquid 25 within the article 2 when the latter is inserted into the cavity 16 of the device 1.

With reference to FIG. 1, which shows the device 1 and the article 2 decoupled from each other, the aerosol generating device 1 comprises a substantially rod-shaped main body having a substantially cylindrical device housing 15. Within a distal portion 4, the device 1 comprises a power supply 12, for example a lithium ion battery, and an electric circuitry 11 including a controller 160 for controlling operation of the device 1, in particular for controlling the heating process. Within a proximal portion 5 opposite to the distal portion 4, the device 1 comprises the receiving cavity 16 and at least parts of the inductive heating arrangement 10. The receiving cavity 16 is an open-ended cavity comprising an insertion opening 19 at the proximal end of device 1 to enable insertion of the article 2 into the receiving cavity 16.

The inductive heating arrangement 10 comprises an induction coil 13 for generating an alternating magnetic field within the cavity 16. The induction coil 13 is a cylindrical-helical coil circumferentially surrounding the cylindrical receiving cavity 16. In the present embodiment, the induction coil 13 has an axial length of about 8 millimeter and is formed by a single layer of 4.25 turns of a coil wire that has a circular cross-section. The turns of the induction coil 13 extend along the length extension of the cavity 16. Preferably, there is a gap between adjacent turns of the induction coil 13. That is, a pitch of the helical induction coil 13 may be larger than a diameter of the coil wire. As a consequence, the coil wire of adjacent turns does not come into contact which each other, which allows to use a coil wire without wire insulation. Nevertheless, the coil wire in the present embodiment is an enamel coated copper wire having a diameter of 1.1 millimeter. In addition, the gap between adjacent turns of the induction coil serves for better heat dissipation and thus leads to less resistive power losses in the coil winding. In the present embodiment, a (center-to-center) distance between adjacent portions of the coil wire of adjacent turns is about 1.1 times the diameter of the coil wire. These ranges have proven to provide a sufficiently large distance which still allows for a compact coil design, that is, a sufficiently large number of turns per length unit.

The induction coil 13 is part of an induction module 30, which in addition to the induction coil 13 further comprises a coil support 17 arranged within the device housing 15 for supporting the induction coil 13. Details of the coil support 17 are shown in FIG. 4. The coil support 17 comprises a cylindrical support tube 32 and a circumferential collar 33 at each axial end of the support tube 32. The more distal collar 33 comprises a recess or feedthrough opening 34 for passing through connecting leads 60 to the induction coil 13 as shown in FIG. 5. As can be seen from FIGS. 1-3, the interior space of the support tube 32 forms at least partially the receiving cavity 16 of the device 1 for removably receiving at least a portion of the aerosol-generating article 2. That is, the inner surface along the inner circumference of the support tube 32 forms at least a portion of an inner surface of the receiving cavity 16. With regard to an easy and inexpensive manufacture, the coil support 17 may be made of plastics. Where the induction heating module 30 must comply with specific regulatory requirements, the coil support 17 may be made, for example, of a bisphenol A-free plastic.

In addition to the induction coil 13, the inductive heating arrangement 10 comprises a power supply electronics which may be integrated at least partially in the electric circuitry 11 and coupled to the induction coil 13 via connection electrical pads 131 (see FIG. 1). In combination with the induction coil 13, the power supply electronics serves to generate a high-frequency alternating current passing through the induction coil 13, which causes the induction coil 31 to generate a high-frequency varying magnetic field within the interior space of the induction coil 12 and thus within the cavity 16 as indicated by the dashed lines in FIG. 2. The frequency of the high-frequency varying magnetic field may be in a range between 500 kHz (kilo-Hertz) to 30 MHz (Mega-Hertz), in particular between 5 MHz (Mega-Hertz) to 15 MHz (Mega-Hertz), preferably between 5 MHz (Mega-Hertz) and 10 MHz (Mega-Hertz). As will be described in more detail further below, the alternating magnetic field is used to induce at least one of heat generating eddy currents or hysteresis losses in the susceptor 22 of the article 2 in order to vaporize the aerosol-forming liquid 25 contained in the article 2.

Next to the device 1, FIG. 1 also shows details of the aerosol-generating article 2. In the present embodiment, the article 2 is a cartridge having a mushroom-type shape that is to be couplable to the device 1. At a distal end, the article 2 comprises an elongate evaporation portion 29 configured to be inserted into the receiving cavity 16 of the device 1, as shown in FIG. 2 and FIG. 3. Within the evaporation portion 29, the article 2 comprises the susceptor 22 that is arranged within the article 2 such that the susceptor 22 is located within the interior space of the induction coil 13, when the evaporation portion 29 of the article 2 is inserted into the cavity 16. Thus, the susceptor 22 may experience the alternating magnetic field generated by the induction coil 13 during operation of the heating arrangement 10 in order to be heated up.

In the present embodiment, the susceptor 22 is a flat, sheet-like mesh made of an inductively heatable ferromagnetic stainless steel. Accordingly, the susceptor 22 may also be denoted as a sheet-like mesh susceptor 22 which is capable to perform both functions: wicking (conveying) and heating the aerosol-forming liquid 25. As the material of the susceptor 22 at hand is both electrically conductive and magnetic, the alternating electromagnetic field of the induction coil 13 can induces both heat generating eddy currents and hysteresis losses in the susceptor material.

The susceptor mesh 22 is in fluid communication with the aerosol-forming liquid 25 contained in a reservoir 24 of the article 2 by means of a wicking porous element 28. The wicking porous element 28 is in direct contact with the liquid 25 in the reservoir 24 and configured to transport the liquid 25 to the mesh susceptor 22. Thus, the susceptor mesh 22 is continuously humidified. Upon inserting the article 2 into the cavity 16 (see FIG. 2 and FIG. 3) and activating the heating arrangement 10, the mesh susceptor 22 is heated up until reaching a temperature sufficient to vaporize the aerosol-forming liquid 25 in contact the mesh susceptor 22.

As can be further seen particularly in FIG. 1, the mesh susceptor 22 is arranged within an airflow channel 26 that passes through the article 2 along its center axis. The airflow channel 26 has an air inlet at the distal end of the article 2 and an outlet at a proximal end of the article 2: The outlet is formed by a mouthpiece 21 which a user can puff on. Hence, when a user takes a puff at the mouthpiece 21 in use of the system, air is entrained into the airflow channel 26 via the air inlet and passes along the mesh susceptor 22. There, vaporized material of the aerosol-forming liquid is entrained into the airflow through the airflow channel 26. Subsequently, while passing further downstream in the airflow channel 26 towards the mouthpiece 21, the airflow including the vaporized material cools down such as to form an aerosol escaping the article 2 through the outlet at the mouthpiece 21.

The aerosol-generating device 1 according to the present embodiment further comprises a puff detector 14 for detecting a user's puff. The puff detector 14 is operatively connected to the power supply electronics such that the detection of the occurrence of a puff by means of the puff detector 14 triggers the power delivery to the induction coil 13 for generating an aerosol. To this extent, the aerosol-generating device 1 according to the present embodiment may be denoted as a puff-on-demand device. Once a user stops puffing, the power delivery to the induction coil is interrupted in order not to generate unnecessarily unused aerosol. That is, the induction heating arrangement is operated intermittently on a user's demand.

While in a continuous operation mode the susceptor would be permanently maintained at a temperature level sufficient to form a satisfactory amount of aerosol, it can be a challenge to achieve a sufficient temperature level within a short period of time if the heating arrangement is to be operated intermittently, such as on a user's demand (puff-on-demand).

In order to achieve a higher heating efficiency, in particular a sufficient temperature level within a shorter period of time, it has been found that it would be advantageous with respect to the flat, sheet-like shape of the susceptor 22 to adapt the geometry of the magnetic field within the interior space of the induction coil 13, where the susceptor 22 is to be placed, to the flat shape of the susceptor 22. In particular, it has been found that by flatting the transverse cross-sectional shape of the induction coil 13, the radial distance between the induction coil 13 and the major surfaces of the flat susceptor 22 can be reduced. The reduced radial distance leads an increase of the magnetic field strength at the susceptor location which in turn causes an increase of the heating efficiency. Thus, the level of heat generated in the susceptor for a given level of power passing through the induction coil is increased which—inter alia—allows to reach a desired temperature level within a shorter period of time. Accordingly, in the present embodiment, the outer circumference of the support tube 32 has a non-circular flattened transverse cross-sectional shape (see dashed line in FIG. 4) consisting of two opposing flat sections 32.1 connected by two opposing at least partially curved sections 32.2. Since the induction coil 13 is wound around the outer circumference of the support tube 32, the transverse cross-sectional shape of the induction coil 13 follows the non-circular flattened transverse cross-sectional shape of the outer circumference of the support tube 32. That is, the cylindrical-helical induction coil 13 also has a non-circular flattened transverse cross-sectional shape (see dotted line on the right in FIG. 5) consisting of two opposing flat sections 13.1 connected by two opposing at least partially curved sections 13.2.

In the present embodiment, the non-circular flattened transverse cross-sectional shape of the support tube 32 and the induction coil 13 is obround, that is a shape consisting of two semicircles 13.2, 32.2 connected by parallel lines 13.1, 32.1 tangent to their endpoints. Accordingly, the induction coil 13 and the support tube 17 have an obround-cylindrical shape.

Due to the parallel and semi-circular portions of the obround shape, the non-circular flattened transverse cross-sectional shape of the induction coil 13 and the support tube 32 comprises a minor axis of symmetry and a major axis of symmetry. As indicated by the dashed-dotted arrows with respect to the induction coil 13 in FIG. 5 on the right, the minor axis of symmetry extends between the two opposing flat sections 13.1 of the induction coil 13, whereas the major axis of symmetry extends between the two opposing curved sections 13.2 of the induction coil. Preferably, a ratio of a maximum distance along the major axis of symmetry between the two opposing at least partially curved sections 13.2, 32.2 to a maximum distance along the minor axis of symmetry between the two opposing flat sections 13.1, 32.1 is in a range between 1.2 and 3, in particular between 1.5 and 2.5. These ratios are particularly advantageous with regard to a proper match between the geometry of the magnetic field and a flat shape of the susceptor 22 to be heated.

In order to further improve the heating efficiency, the inductive heating arrangement 10 of the present embodiment comprises a flux concentrator 50 which is arranged around the induction coil 13 and configured to distort the alternating magnetic field of the induction heating arrangement 10 towards the interior space of the induction coil 13 during use. For this purpose, the flux concentrator 50 has a specific configuration comprising a sleeve portion 52 circumferentially surrounding the induction coil 13 and in addition an annular protrusion portion 51 at each axial end of the sleeve portion 52 protruding radially inward beyond the sleeve portion 51, such that the induction coil 13 is axially arranged between the annular protrusion portions 51, as can be particularly seen in FIG. 1 and FIG. 2. Hence, as seen in a longitudinal cross-section through the flux concentrator 50 along a length axis of the induction coil 13 (see FIG. 1 and FIG. 2), the flux concentrator 50 has a U- or C-shape, wherein the sleeve portion 52 is part of the base of the U- or C-shape and the annular protrusion portions 51 are part of the arms or legs of the U- or C-shape. To this extent, it has been found that the density of the magnetic field at the location of the susceptor 22 can be increased by distorting the magnetic field towards the interior space of the induction coil 13 using a flux concentrator 50 which is shaped as described above. In particular, the annular protrusion portions 51 at each axial end of the sleeve portion 52 protruding radially inward beyond the sleeve portion 52 lead to a concentration or focusing of the magnetic field within the interior space of the induction coil 13. Thus, the level of heat generated in the susceptor 22 for a given level of power passing through the induction coil 13 is increased in comparison to an induction coil having no flux concentrator or only a sleeve-shaped flux concentrator without annular protrusion portions at each axial end. In addition to that, the flux concentrator 50 acts as a magnetic shield which is capable of reducing the extent to which the magnetic field propagates beyond the induction coil 13. Thus, the flux concentrator 50 can help to reduce undesired heating of other susceptive parts of the system or susceptive items external to the device 1.

While the annular protrusion portions 51 should extend radially inward beyond an outer circumference of the induction coil 13 in order to ensure a sufficient concentration of the magnetic field, it may be sufficient, if the annular protrusion portions 51 extend radially inward at most to an inner circumference of the induction coil 13, that is, if the annular protrusion portions do not protrude radially inward beyond the inner circumference of the induction coil 13.

In the present embodiment, the flux concentrator 50 is built up from a flux concentrator foil. More particularly, each of the annular protrusion portions 51 is made of a flux concentrator foil which is spirally wound up on the coil support 17 in a plurality of layers such as to extend radially outward beyond an outer circumference of the induction coil 13. On top of the annular protrusion portions 51, the sleeve portion 52 is formed of several layers of the same flux concentrator foil material such as to surround the induction coil 13 and each of the annular protrusion portions 51. As an example, a flexible three-layer ferrite sheet comprising a ferrite layer sandwiched between an adhesive layer and a cover layer, that is available from the company Laird under the product name MHLL6060-300, can be used as flux concentrator foil. MHLL6060-300 has a foil thickness of about 90 micrometer, a real magnetic permeability of about 130 and an imaginary magnetic permeability of about 5 at a frequency of 13.56 MHz. At hand, each of the annular protrusion portions 51 shown in FIGS. 1-3 has a height dimension (in the radial direction) of 2 millimeter and a width dimensions (in the axial direction) of 2 millimeter. The sleeve portion 52 has a thickness dimension (in the radial direction) of about 180 micrometer and a width dimensions (in the axial direction) of 10 millimeter. Hence, using a foil material with a foil thickness of 90 micrometer requires about 22 windings to form the annular protrusion portions 51 of 2 millimeter height, and about 2 windings to form the sleeve portion 52 of 180 micrometer thickness.

The sleeve portion 52 is spaced from the induction coil 13 in the radial direction by a radial gap, having a width (radial extension) in a range between 0.5 millimeter and 1.5 millimeter, in particular between 0.8 millimeter and 1 millimeter. Advantageously, the radial gap may help to avoid heat losses from the induction coil to the sleeve portion, to reduce losses in the induction coil and to increase losses in the susceptor 22 to be heated, that is, to increase the heating efficiency of the aerosol-generating device 1. Likewise, each of the annular protrusion portions 51 is spaced from the induction coil 13 in the axial direction by an axial gap. The radial gap and/or the axial gap may be an air gap or a gap filled at least partially with a filler material.

Similar to the support tube 32 and the induction coil 13, the flux concentrator 50 may also have a non-circular flattened transverse cross-sectional shape corresponding to the non-circular flattened transverse cross-sectional shape of the support tube 32 and the induction 13. In particular, the transverse cross-sectional shape of the flux concentrator 50 may be obround.

As shown in FIG. 6, the more distal annular protrusion portions 51 comprise a recess or feedthrough opening 501 for passing through the connecting leads 60 for the induction coil. The recess or feedthrough opening 501 can be cut into the annular protrusion portion 51 after winding the flux concentrator foil.

In order to further increase the heating efficiency, the outer circumference of the support tube 32 of the present embodiment comprises a helical wire recess pattern 39—as shown in FIG. 4 and FIG. 6—which the coil wire is received in. Advantageously, the wire recess pattern 39 allows to further reduce the radial distance between the induction coil 13 and the susceptor location within the interior space of the induction coil 13. As already described above, a reduced radial distance leads an increase of the magnetic field strength at the location of the susceptor which in turn causes an increase of the heating efficiency.

The larger the depth of the recesses of the wire recess pattern 39, the better the magnetic field strength at the susceptor location within the interior space of the induction coil 13. For example, where the coil wire has a circular cross-section, a depth of the recesses of the wire recess pattern 39 in the radial direction preferably is in a range between 0.2 and 0.8, in particular 0.3 and 0.5, times a diameter of the coil wire. A distance in the radial direction between the induction coil 13 and an inner circumference of the coil support 17 may be in a range between 0.1 millimeter and 1 millimeter, in particular between 0.2 millimeter and 0.5 millimeter, preferably about 0.3 millimeter, as indicated in FIG. 6. This ensures a particular short radial distance between the induction coil 13 and the interior space of the support tube 32, where the susceptor 22 is to be received. That is, a in the radial direction between an inner circumference of the support tube 32 and a bottom of the recess pattern 39 is in a range between 0.1 millimeter and 1 millimeter, in particular between 0.2 millimeter and 0.5 millimeter, preferably about 0.3 millimeter.

A shown in FIG. 2 and FIG. 6, the outer circumference of the support tube 32 may further comprise a flux concentrator recess 38 for each of the annular protrusion portions 51 of the flux concentrator 50, in which a radially inward end of the respective annular protrusion portion 51 is received. Due to this, the annular protrusion portions 51 are safely supported which helps to prevent the flux concentrator 50 from being displaced. Otherwise, a displacement could lead to an undesired change in the inductance of the induction coil 13 and an undesired change of the magnetic field density in the interior space of the induction coil 13.

FIG. 7 shows further details of the inductive heating arrangement 10, in particular the power supply electronics that can be used in the aerosol-generating device shown in FIGS. 1-3. According to the present embodiment, the inductive heating arrangement 10 comprises a DC/AC inverter which is connect to the DC power supply 12 shown in FIG. 1. The DC/AC inverter includes a Class-E power amplifier which in turn includes the following components: a transistor switch 111 comprising a Field Effect Transistor T (FET), for example a Metal-Oxide-Semiconductor Field Effect Transistor (MOSFET), a transistor switch supply circuit indicated by the arrow 112 for supplying the switching signal (gate-source voltage) to the transistor switch 111, and an LC load network 113 comprising a shunt capacitor C1 and a series connection of a capacitor C2 and inductor L2. The inductor L2 corresponds to the induction coil 13 shown in FIG. 1-3 that is used to generate an alternating magnetic field within the cavity 16. In addition, there is provided a choke L1 for supplying a DC supply voltage +V_DC from the DC power supply 12. Also shown in FIG. 7 is the ohmic resistance R representing the total equivalent resistance or total resistive load 114, which—in use of the system, that is, when the article 2 is inserted in the cavity 16 of the device 1—is the sum of the ohmic resistance of the induction coil 13, marked as L2, and the ohmic resistance of the susceptor 22. Otherwise, in case no article is inserted in the cavity 16, the equivalent resistance or resistive load 114 only corresponds to the ohmic resistance of the induction coil 13.

FIG. 8 shows another embodiment of the power supply electronics that can be alternatively used in the aerosol-generating device shown in FIGS. 1-3 in order to provide a high frequency oscillating current to the induction coil 13. The configuration shown in FIG. 8 corresponds to the configuration of a class-D amplifier. There, the DC power supply 12 is connected to two transistors 1210, 1212. Two switching elements 1220, 1222 are provided for switching the two transistors 1210, 1212 on and off. The switching elements 1220, 1222 are controlled at high frequency in a manner so as to make sure that one of the two transistors 1210, 1212 has been switched off at the time the other of the two transistors is switched on. The induction coil 13 used to generated the alternating magnetic field for induction heating is again indicated by L2, whereas the combined ohmic resistance of the induction coil 13 and the susceptor 22 is indicated by R. The values of C1 and C2 can be chosen to maximize the efficient dissipation of power in the susceptor element. The capacitor C1 is not essential to configure the architecture as a class-D and thus can be omitted.

For the purpose of the present description and of the appended claims, except where otherwise indicated, all numbers expressing amounts, quantities, percentages, and so forth, are to be understood as being modified in all instances by the term “about”. Also, all ranges include the maximum and minimum points disclosed and include any intermediate ranges therein, which may or may not be specifically enumerated herein. In this context, therefore, a number A is understood as A ±5% of A. Within this context, a number A may be considered to include numerical values that are within general standard error for the measurement of the property that the number A modifies. The number A, in some instances as used in the appended claims, may deviate by the percentages enumerated above provided that the amount by which A deviates does not materially affect the basic and novel characteristic(s) of the claimed invention. Also, all ranges include the maximum and minimum points disclosed and include any intermediate ranges therein, which may or may not be specifically enumerated herein.

1.-15. (canceled)

16. An aerosol-generating system, comprising:
an aerosol-generating article and an inductively heating aerosol-generating device for the aerosol-generating article,
the aerosol-generating article comprising an aerosol-forming liquid and a flat sheet-like susceptor arranged in an evaporation portion of the aerosol-generating article and configured for heating the aerosol-forming liquid by interaction of the flat sheet-like susceptor with an alternating magnetic field provided by the aerosol-generating device, and
the aerosol-generating device comprising a DC power supply and an induction heating arrangement, the induction heating arrangement comprising power supply electronics comprising a DC/AC inverter connected to the DC power supply,
wherein the DC/AC inverter comprises a power switching amplifier with at least one transistor switch, at least one transistor switch driver circuit associated with the transistor switch, and an LC load network comprising at least a capacitor and a cylindrical-helical induction coil,
wherein an interior space of the cylindrical-helical induction coil is configured for removably receiving at least the evaporation portion of the aerosol-generating article, and
wherein the cylindrical-helical induction coil has a non-circular flattened transverse cross-sectional shape comprising two opposing flat sections connected by two opposing at least partially curved sections.

17. The aerosol-generating system according to claim 16, wherein the non-circular flattened transverse cross-sectional shape comprises a minor axis of symmetry and a major axis of symmetry.

18. The aerosol-generating system according to claim 17, wherein a ratio of a maximum distance along the major axis of symmetry between the two opposing at least partially curved sections to a maximum distance along the minor axis of symmetry between the two opposing flat sections is in a range between 1.2 and 3.

19. The aerosol-generating system according to claim 17, wherein a ratio of a maximum distance along the major axis of symmetry between the two opposing at least partially curved sections to a maximum distance along the minor axis of symmetry between the two opposing flat sections is in a range between 1.5 and 2.5.

20. The aerosol-generating system according to claim 17, wherein a maximum distance along the minor axis of symmetry between the two opposing flat sections is in a range between 4 millimeters and 7 millimeters.

21. The aerosol-generating system according to claim 17, wherein a maximum distance along the minor axis of symmetry between the two opposing flat sections is in a range between 5 millimeters and 6 millimeters.

22. The aerosol-generating system according to claim 17, wherein a maximum distance along the major axis of symmetry between the two opposing at least partially curved sections is in a range between 7 millimeters and 10 millimeters.

23. The aerosol-generating system according to claim 17, wherein a maximum distance along the major axis of symmetry between the two opposing at least partially curved sections is in a range between 8 millimeters and 9 millimeters.

24. The aerosol-generating system according to claim 16, wherein the two opposing flat sections are parallel to each other.

25. The aerosol-generating system according to claim 16, wherein each of the two opposing flat sections is a substantially straight line.

26. The aerosol-generating system according to claim 16, wherein each of the two opposing at least partially curved sections is substantially semi-circular, substantially semi-oval, substantially semi-elliptical, or substantially parabolic.

27. The aerosol-generating system according to claim 16, wherein the non-circular flattened transverse cross-sectional shape of the cylindrical-helical induction coil is obround.

28. The aerosol-generating system according to claim 16, wherein the cylindrical-helical induction coil has a cylindrical obround shape.

29. The aerosol-generating system according to claim 16, wherein the cylindrical-helical induction coil is formed by one or more turns of a coil wire, the coil wire having a circular cross-section.

30. The aerosol-generating system according to claim 16, wherein the switching power amplifier is a single-ended switching power amplifier.

31. The aerosol-generating system according to claim 16, wherein the switching power amplifier is one of a class-C power amplifier, a class-D power amplifier, and a class-E power amplifier.

32. The aerosol-generating system according to claim 16, wherein the inductive heating arrangement is configured to generate an alternating magnetic field in a range between 500 kHz to 30 MHz.

33. The aerosol-generating system according to claim 16, wherein the inductive heating arrangement is configured to generate an alternating magnetic field in a range between 5 MHz to 15 MHz.

34. The aerosol-generating system according to claim 16, wherein the inductive heating arrangement is configured to generate an alternating magnetic field in a range between 5 MHz and 10 MHz.

35. The aerosol-generating system according to claim 16, wherein the flat sheet-like susceptor is placed such that major surfaces of the flat sheet-like susceptor are aligned with the two opposing flat sections of the transverse cross-sectional shape of the cylindrical-helical induction coil, when the evaporation portion of the aerosol-generating article is received in the interior space of the cylindrical-helical induction coil.
